(19) United States
(12) Patent Application Publication
(10) Pub. No.: US 2023/0126986 A1
(43) Pub. Date: Apr. 27, 2023

(54) METHODS FOR CSI REPORT TRANSMITTED ON MULTI-SLOT PUSCH

(71) Applicant: QUALCOMM Incorporated, San Diego, CA (US)

(72) Inventors: Chenxi HAO, Beijing (CN); Yi HUANG, San Diego, CA (US); Pranay Sudeep RUNGTA, New York, NY (US); Chao JIN, San Diego, CA (US); Yu ZHANG, San Diego, CA (US); Peter GAAL, San Diego, CA (US)

(21) Appl. No.: 17/906,246

(22) PCT Filed: Apr. 20, 2020
(86) PCT No.: PCT/CN2020/085678

§ 371 Date: Sep. 13, 2022

(51) Int. Cl. H04W 72/1268; H04L 5/00

(52) U.S. Cl. CPC H04W 72/1268; H04L 5/0057

(57) ABSTRACT

Certain aspects of the present disclosure provide methods for channel state information (CSI) reports transmitted on a multi-slot physical uplink shared channel (PUSCH). A method that may be performed by a user equipment (UE) includes receiving a grant triggering an aperiodic channel state information (A-CSI) transmission in a slot overlapping a scheduled transmission with slot aggregation of multiple PUSCH slots, determining CSI timing conditions based on a set of signals transmitted on only a subset of the multiple PUSCH slots, and sending A-CSI reports in one or more of the aggregated slots that satisfy the CSI timing conditions.

### BACKGROUND

### Field of the Disclosure

Aspects of the present disclosure relate to wireless communications, and more particularly, to techniques for aperiodic channel state information transmission (A-CSI) with slot aggregation, for example, on a slot aggregated physical uplink control channel (PUCCH) or a slot aggregated physical uplink shared channel (PUSCH).

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “detailed description” one will understand how the features of this disclosure provide advantages that include improved methods for channel state information (CSI) reports transmitted on multi-slot physical uplink shared channels (PUSCH).

Certain aspects of the subject matter described in this disclosure can be implemented in a method for wireless communication by a user equipment (UE). The method generally includes receiving a grant triggering an aperiodic channel state information (A-CSI) transmission in a slot overlapping a scheduled transmission with slot aggregation of multiple PUSCH slots. The method generally includes determining CSI timing conditions based on a set of signals transmitted on only a subset of the multiple PUSCH slots. The method generally includes sending A-CSI reports in one or more of the aggregated slots that satisfy the CSI timing conditions, determining one or more of the aggregated slots to transmit the A-CSI, and transmitting the A-CSI in the determined one or more of the aggregated slots.

Certain aspects of the subject matter described in this disclosure can be implemented in a method for wireless communication by a network entity. The method generally includes sending a UE a grant triggering a A-CSI transmission in a slot overlapping a scheduled transmission with slot aggregation of multiple PUSCH slots, determining CSI timing conditions based on a set of signals transmitted on only a subset of the multiple PUSCH slots, and monitoring for A-CSI reports in one or more of the aggregated slots that satisfy the CSI timing conditions.

Certain aspects of the subject matter described in this disclosure can be implemented in a method for wireless communication by a UE. The method generally includes receiving signaling triggering or configuring a CSI report transmission in a slot overlapping a scheduled transmission with slot aggregation of multiple PUSCH slots, and determining at least one of a CSI reference signal (CSI-RS) active duration, CSI processing unit (CPU) occupation time, or a location of a CSI reference resource for the CSI report, when the CSI report is sent on multiple PUSCH slots.

Certain aspects of the subject matter described in this disclosure can be implemented in a method for wireless communication by a network entity. The method generally includes sending, to a network entity, signaling triggering or configuring a CSI report transmission in a slot overlapping a scheduled transmission with slot aggregation of multiple PUSCH slots and determining at least one of a CSI-RS active duration, CPU occupation time, or a location of a CSI reference resource for the CSI report, when the CSI report is sent on multiple PUSCH slots.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for new radio (NR), in accordance with certain aspects of the present disclosure.

FIG. 4A is an example uplink control information (UCI) scheduled on a physical uplink control channel (PUCCH) overlapping a scheduled physical uplink shared channel (PUSCH) with slot aggregation and piggybacking the UCI on PUSCH.

FIG. 4B is an example UCI scheduled on a PUCCH overlapping another scheduled PUCCH with slot aggregation and dropping the UCI PUCCH.

FIGS. 5A-5C illustrate and define an example aperiodic channel state information (A-CSI) timeline for A-CSI triggered by an uplink (UL) grant and piggybacking on a PUSCH.

FIG. 6 is an example of an A-CSI report transmitted on a middle PUSCH slot of the aggregated slots of the PUSCH, in accordance with certain aspects of the present disclosure.

FIG. 7 is an example of an A-CSI report transmitted on the all PUSCH slots of the aggregated slots of the PUSCH that satisfy a time-gap, in accordance with certain aspects of the present disclosure.

FIG. 8 illustrates example operations for wireless communication by a UE, in accordance with certain aspects of the present disclosure.

FIG. 9 illustrates example operations for wireless communication by a network entity, in accordance with certain aspects of the present disclosure.

FIG. 10 is a call flow diagram illustrating example signaling for A-CSI with slot aggregation, in accordance with aspects of the present disclosure.

FIG. 11A-11C illustrate examples of A-CSI transmitted on aggregated PUSCH slots, in accordance with certain aspects of the present disclosure.

FIG. 12 illustrates example operations for wireless communication by a UE, in accordance with certain aspects of the present disclosure.

FIG. 13 illustrates example operations for wireless communication by a network entity, in accordance with certain aspects of the present disclosure.

FIGS. 14A-14B illustrate examples of CSI transmitted on aggregated PUSCH slots, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for aperiodic channel state information (A-CSI) transmission with slot aggregation.

In some examples, A-CSI may be configured for transmission in a physical uplink control channel (PUCCH) overlapping with another scheduled slot aggregated PUCCH or overlapping with a scheduled slot aggregated physical uplink shared channel (PUSCH).

According to aspects of the present disclosure, the A-CSI may be transmitted in only one of the aggregated slots or repeated in multiple of the aggregated slots. In some examples, the A-CSI transmission may satisfy a configured or specified A-CSI timeline. In some examples, the aggregated slot (or slots) in which the A-CSI is transmitted may be selected to satisfy (or increase the probability of satisfying) the A-CSI timeline.

The following description provides examples of A-CSI transmission on slot aggregated PUCCH or slot aggregated PUSCH in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

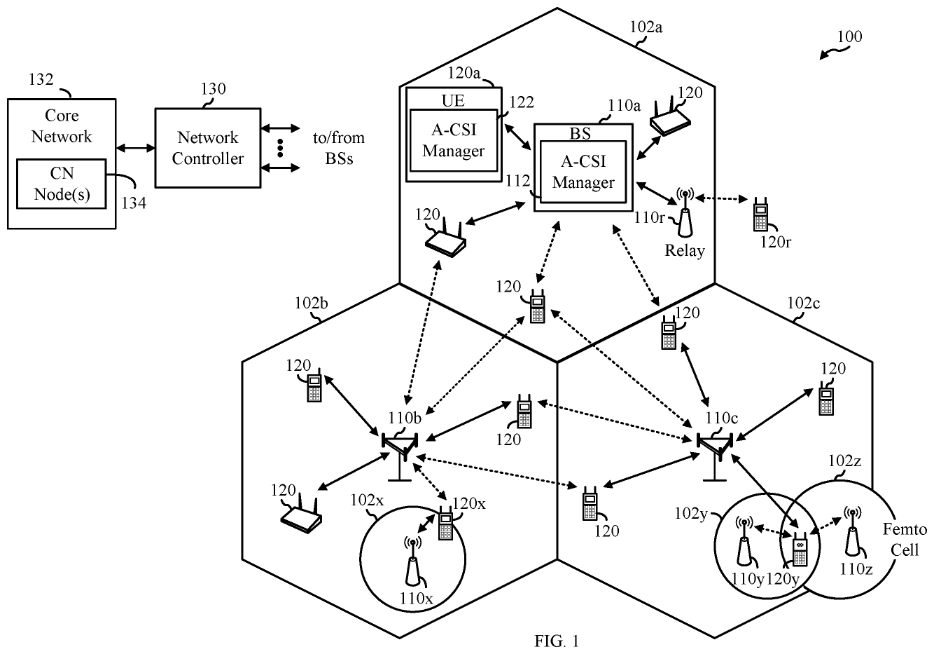

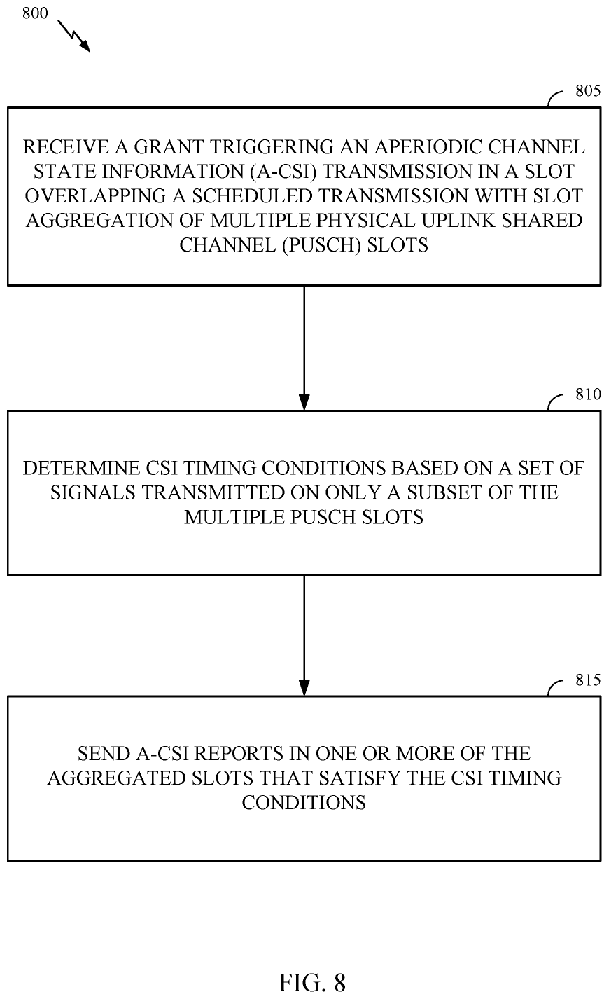

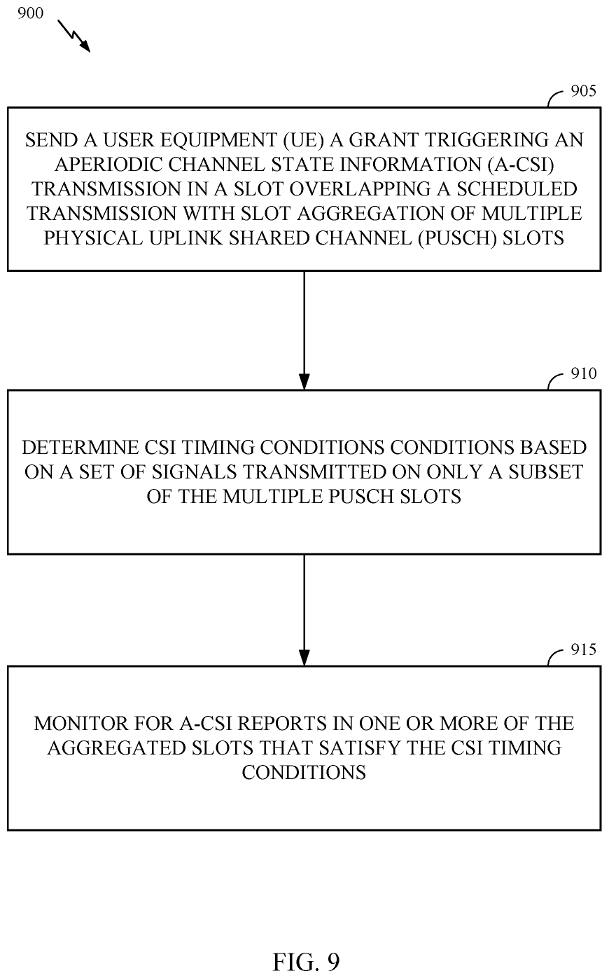

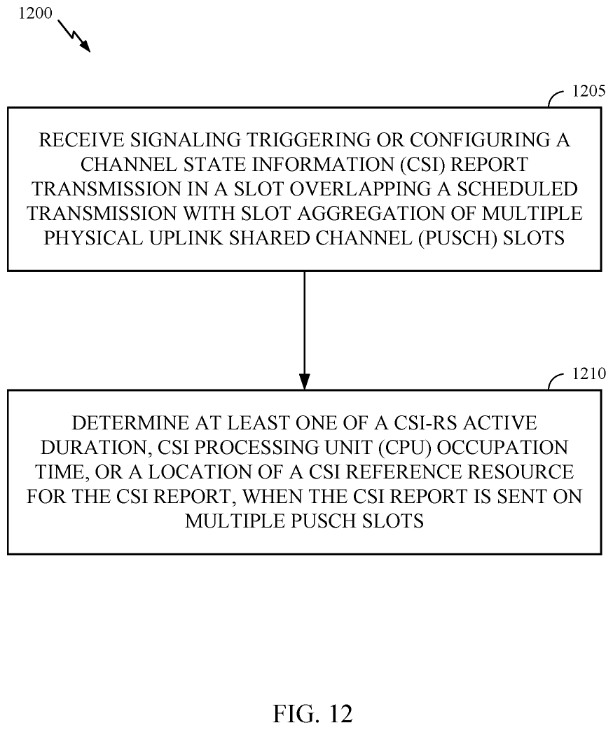

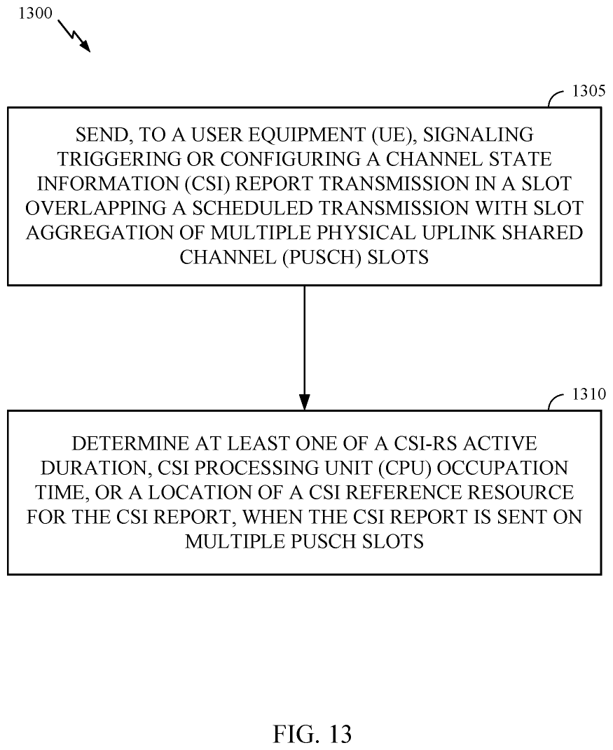

FIG. 1 illustrates an example wireless communication network 100 in which aspects of the present disclosure may be performed. For example, the wireless communication 100 may include a BS 110a that includes an A-CSI manager 112 configured to perform operations 900 of FIG. 9 and/or operations 1300 of FIG. 13 described below. Similarly, a UE 120a may include an A-CSI manager 122 configured to perform operations 800 of FIG. 8 and/or operation 1200 of FIG. 12.

The wireless communication network 100 may be an NR system (e.g., a 5G NR network). As shown in FIG. 1, the wireless communication network 100 may be in communication with a core network 132. The core network 132 may in communication with one or more base station (BSs) 110 and/or user equipment (UE) 120 in the wireless communication network 100 via one or more interfaces.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. A network controller 130 may couple to a set of BSs 110 and provide coordination and control for these BSs 110 (e.g., via a backhaul).

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

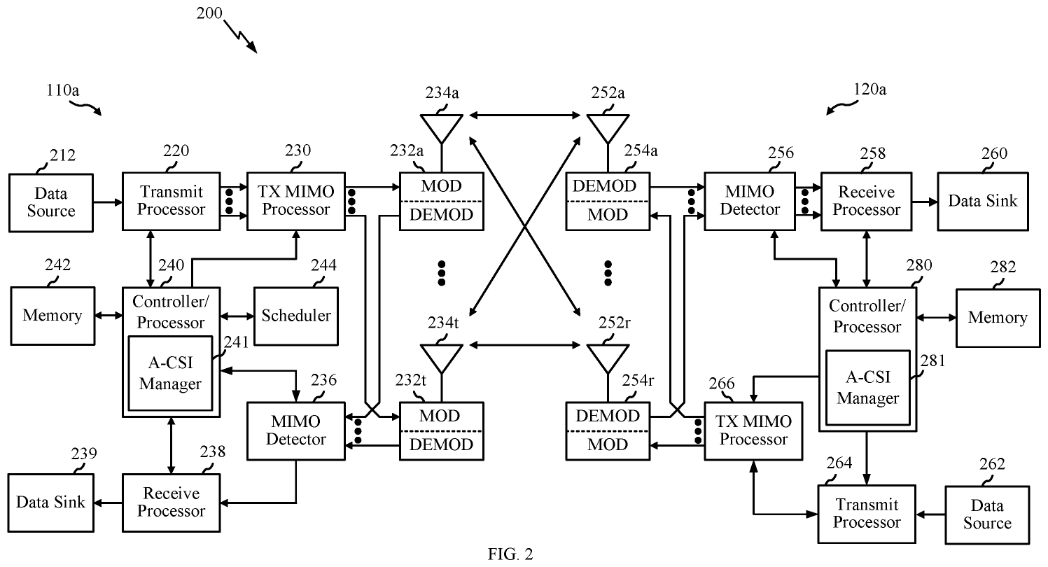

FIG. 2 illustrates example components of BS 110a and UE 120a (e.g., in the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 240 of the BS 110a has an A-CSI placement manager 241 that may be configured for A-CSI transmission on a slot aggregated PUCCH or a slot aggregated PUSCH, according to aspects described herein. As shown in FIG. 2, the controller/processor 280 of the UE 120a has an A-CSI placement manager 281 that may be configured for A-CSI transmission on a slot aggregated PUCCH or a slot aggregated PUSCH, according to aspects described herein. Although shown at the controller/processor, other components of the UE 120a and BS 110a may be used to perform the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

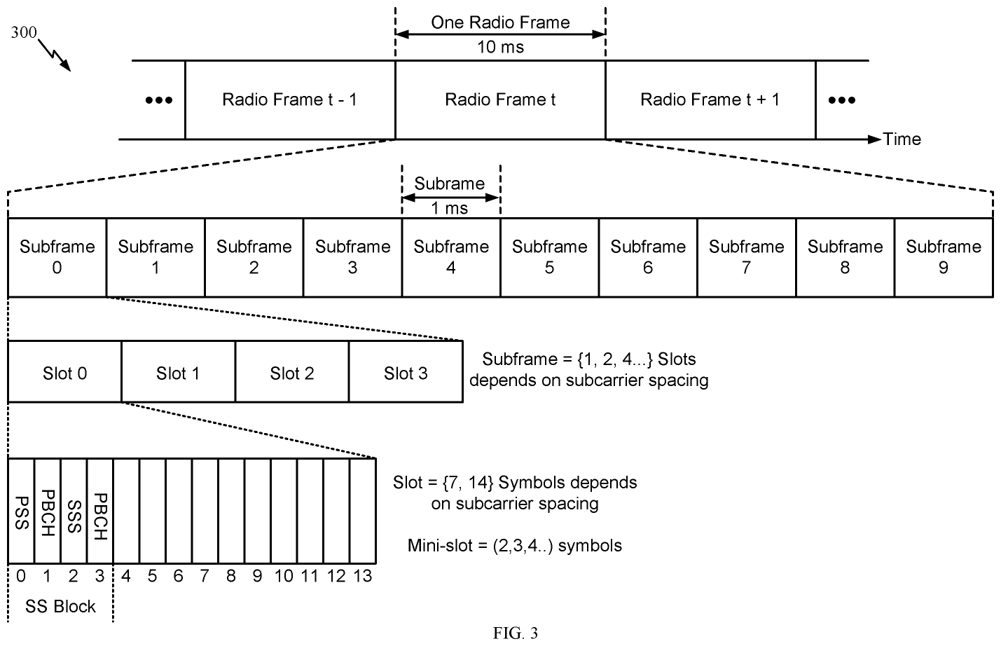

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7 or 14 symbols) depending on the SCS. The symbol periods in each slot may be assigned indices. A mini-slot, which may be referred to as a sub-slot structure, refers to a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

Aspects of the present disclosure related to channel state information (CSI) feedback.

CSI may refer to channel properties of a communication link. The CSI may represent the combined effects of, for example, scattering, fading, and power decay with distance between a transmitter and receiver. Channel estimation using pilots, such as CSI reference signals (CSI-RS), may be performed to determine these effects on the channel. CSI may be used to adapt transmissions based on the current channel conditions, which is useful for achieving reliable communication, in particular, with high data rates in multi-antenna systems. CSI is typically estimated at the receiver, quantized, and fed back to the transmitter.

A UE (e.g., such as a UE 120a) may be configured by a BS (e.g., such as a BS 110) for CSI reporting. The BS may configure the UE with a CSI reporting configuration or with multiple CSI report configurations. The BS may provide the CSI reporting configuration to the UE via higher layer signaling, such as radio resource control (RRC) signaling (e.g., via a CSI-ReportConfig information element (IE)).

Each CSI report configuration may be associated with a single downlink bandwidth part (BWP). The CSI report setting configuration may define a CSI reporting band as a subset of subbands of the BWP. The associated DL BWP may indicated by a higher layer parameter (e.g., bwp-Id) in the CSI report configuration for channel measurement and contains parameter(s) for one CSI reporting band, such as codebook configuration, time-domain behavior, frequency granularity for CSI, measurement restriction configurations, and the CSI-related quantities to be reported by the UE. Each CSI resource setting may be located in the DL BWP identified by the higher layer parameter, and all CSI resource settings may be linked to a CSI report setting have the same DL BWP.

The CSI report configuration may configure the time and frequency resources used by the UE to report CSI. For example, the CSI report configuration may be associated with CSI-RS resources for channel measurement (CM), interference measurement (IM), or both. The CSI report configuration may configure CSI-RS resources for measurement (e.g., via a CSI-ResourceConfig IE). The CSI-RS resources provide the UE with the configuration of CSI-RS ports, or CSI-RS port groups, mapped to time and frequency resources (e.g., resource elements (REs)). CSI-RS resources can be zero power (ZP) or non-zero power (NZP) resources. At least one NZP CSI-RS resource may be configured for CM. For interference measurement, it can be NZP CSI-RS or zero power CSI-RS, which is known as CSI-IM (note, if NZP CSI-RS, it is called NZP CSI-RS for interference measurement, if zero power, it is called CSI-IM)

The CSI report configuration may configure the UE for aperiodic, periodic, or semi-persistent CSI reporting. For periodic CSI, the UE may be configured with periodic CSI-RS resources. Periodic CSI and semi-persistent CSI report on physical uplink control channel (PUCCH) may be triggered via RRC or a medium access control (MAC) control element (CE). For aperiodic and semi-persistent CSI on the physical uplink shared channel (PUSCH), the BS may signal the UE a CSI report trigger indicating for the UE to send a CSI report for one or more CSI-RS resources, or configuring the CSI-RS report trigger state (e.g., CSI-AperiodicTriggerStateList and CSI-SemiPersistentOnPUSCH-TriggerStateList). The CSI report trigger for aperiodic CSI and semi-persistent CSI on PUSCH may be provided via downlink control information (DCI). The CSI-RS trigger may be signaling indicating to the UE that CSI-RS will be transmitted for the CSI-RS resource. The UE may report the CSI feedback based on the CSI report configuration and the CSI report trigger. For example, the UE may measure the channel associated with CSI for the triggered CSI-RS resources. Based on the measurements, the UE may select a preferred CSI-RS resource. The UE reports the CSI feedback for the selected CSI-RS resource.

The CSI report configuration can also configure the CSI parameters (sometimes referred to as quantities) to be reported. Codebooks may include Type I single panel, Type I multi-panel, and Type II single panel. Regardless which codebook is used, the CSI report may include at least the channel quality indicator (CQI), precoding matrix indicator (PMI), CSI-RS resource indicator (CRI), and rank indicator (RI). The structure of the PMI may vary based on the codebook. The CRI, RI, and CQI may be in a first part (Part I) and the PMI may be in a second part (Part II) of the CSI report.

For the Type I single panel codebook, the PMI may include a W1 matrix (e.g., subest of beams) and a W2 matrix (e.g., phase for cross polarization combination and beam selection). For the Type I multi-panel codebook, compared to type I single panel codebook, the PMI further comprises a phase for cross panel combination. The BS may have a plurality of transmit (TX) beams. The UE can feed back to the BS an index of a preferred beam, or beams, of the candidate beams. For example, the UE may feed back the precoding vector w for the l-th layer:

$${w}_{l} = ( \begin{matrix}{b}_{+ 45 pol} \\ φ \cdot {b}_{- 45 pol}\end{matrix} )$$

where b represents the oversampled beam (e.g., discrete Fourier transform (DFT) beam), for both polarizations, and φ is the co-phasing.

For the Type II codebook (e.g., which may be designed for single panel), the PMI is a linear combination of beams; it has a subset of orthogonal beams to be used for linear combination and has per layer, per polarization, amplitude and phase for each beam. The preferred precoder for a layer can be a combination of beams and associated quantized coefficients, and the UE can feedback the selected beams and the coefficients to the BS.

The UE may report the CSI feedback based on the CSI report configuration and the CSI report trigger. For example, the UE may measure the channel associated with CSI for the triggered CSI-RS resources. Based on the measurements, the UE may select a preferred CSI-RS resource. The UE reports the CSI feedback for the selected CSI-RS resource. LI may be calculated conditioned on the reported CQI, PMI, RI and CRI; CQI may be calculated conditioned on the reported PMI, RI and CRI; PMI may be calculated conditioned on the reported RI and CRI; and RI may be calculated conditioned on the reported CRI.

In 5G new radio (NR), frame structure is flexible to support a wide array of services and to meet quality of service requirements. Slots within the frame structure can be reduced to mini-slots to support transmission across fewer than fourteen symbols, or they can be aggregated to support transmission across more than fourteen symbols. Dynamic selection of available slot configurations promotes low-latency, high efficiency transmission. Slot aggregation within the NR frame structure allows some flexibility for time domain duplex (TDD) operations, which promotes a high-data rate for enhanced mobile broadband (eMBB). Thus, with slot aggregation, a transmission can span more than one slot, for example, to improve coverage and/or reduce overhead. For a transmission with slot aggregation, the same transport block(s) (TB) may be repeated in each of the aggregated slots.

The UE may be configured to transmit uplink (UL) control information (UCI). The UCI may include hybrid automatic repeat request (HARQ) feedback (e.g., HARQ-ACK), periodic channel state information (P-CSI) feedback, and/or semi-persistent CSI (SP-CSI) feedback. In some systems (e.g., Release 15 and/or Release 16 systems), the UE is configured to transmit the UCI on scheduled physical uplink control channel (PUCCH) resources. In some examples, the PUCCH overlaps with another scheduled transmission, such as a physical uplink shared channel (PUSCH) transmission or another PUCCH transmission. In some cases, the overlapping transmission may be scheduled/configured for slot aggregation.

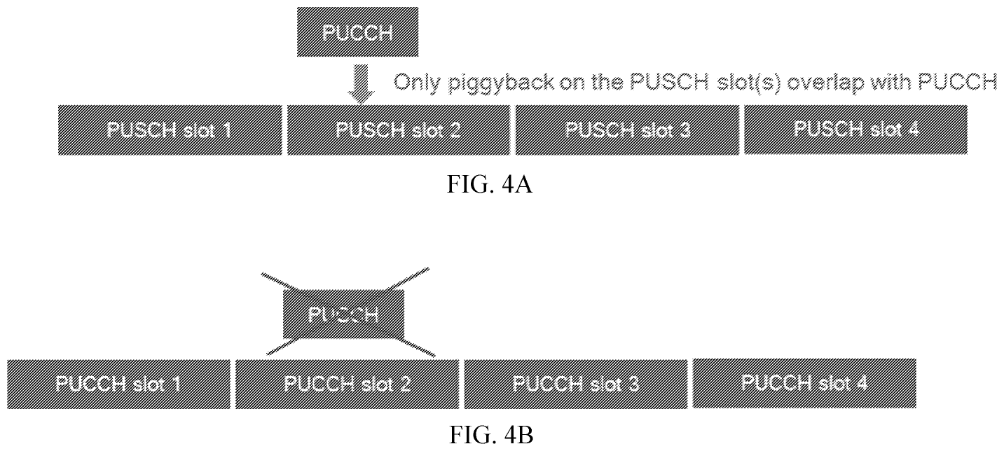

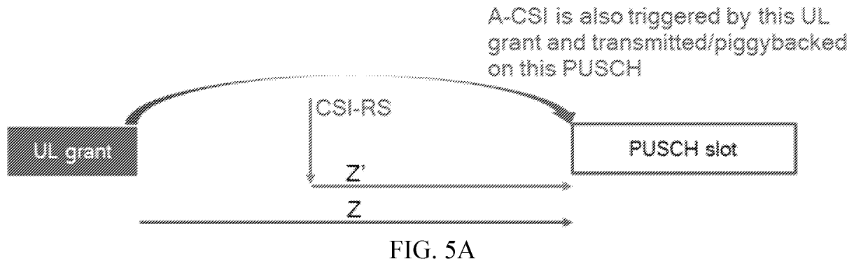

As shown in FIG. 4A, where the PUCCH for the UCI overlaps with a slot scheduled for a PUSCH transmission (in this example, the PUSCH having a slot aggregation factor=4), the UE may piggyback the UCI transmission on the PUSCH slot(s) that overlap with the PUCCH. In the example in FIG. 4A, the UE may transmit the UCI with the PUSCH in the PUSCH slot 2, and the PUCCH may be dropped (e.g., the UE does not transmit on the PUCCH resource).

As shown in FIG. 4B, where the PUCCH overlaps with a slot of another PUCCH transmission, the UE may drop the UCI transmission entirely.

As discussed, the UE may be configured for aperiodic CSI (A-CSI) transmission. For example, the UE may be RRC configured with the CSI reporting configuration for providing A-CSI feedback. For A-CSI, the A-CSI feedback may be triggered by downlink control information (DCI). For example, DCI carrying a grant may trigger A-CSI feedback on an uplink resource. The DCI may also trigger CSI-RS resources. Thus, the UE may measure CSI-RS on the triggered CSI-RS resources, determine A-CSI feedback, and send the CSI report with the A-CSI on the triggered uplink resource.

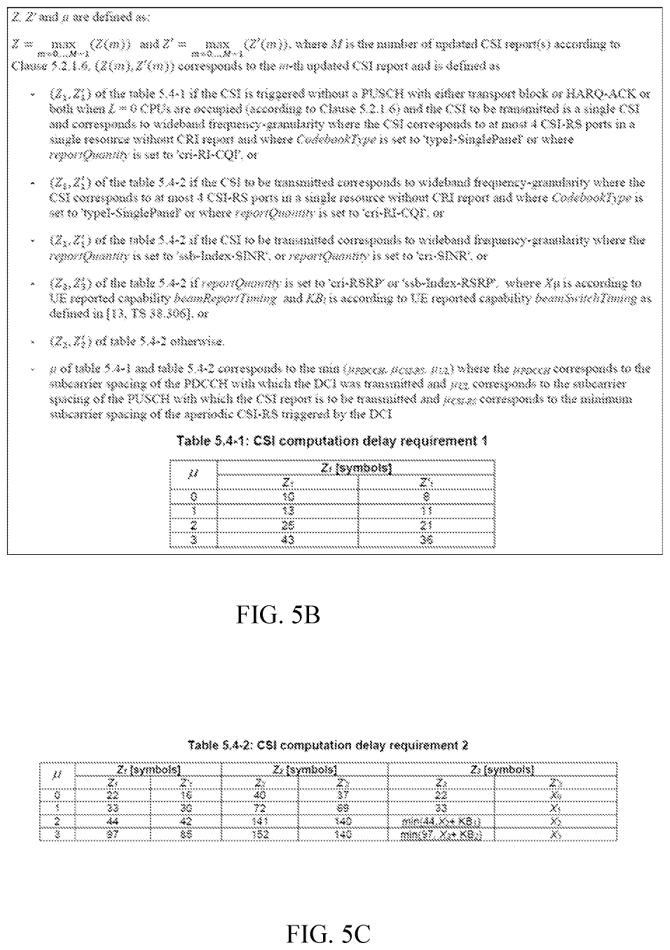

The A-CSI reporting satisfies an A-CSI timeline. For example, the A-CSI reporting may satisfy certain time-gap thresholds before transmission. For example, as shown in FIG. 5, an A-CSI transmission may be triggered by a UL grant and transmitted/piggybacked on a PUSCH slot. As shown in FIG. 5, the A-CSI transmission is after a first time gap from the last orthogonal frequency-division multiplexing (OFDM) symbol of the PDCCH carrying the UL grant to the first OFDM symbol of the PUSCH carrying the A-CSI report (i.e., the first time gap is greater than or equal to a first threshold of Z symbols). As shown in FIG. 5, the A-CSI transmission is also after a second time gap from the last OFDM symbol of the CSI-RS to the first OFDM symbol of the PUSCH carrying the A-CSI report (i.e., the second time gap is greater or equal to a second threshold of Z′ symbols).

In some cases; however, the A-CSI may be triggered on a slot aggregated resource. For example, the UL grant may trigger the A-CSI in a slot aggregated PUSCH. In other words, with A-CSI, unlike period or semi-persistent CSI, the A-CSI may have any configured resource for the A-CSI transmission, instead, the A-CSI is triggered together in the grant with the slot aggregated transmission.

### Example A-CSI Transmission

As discussed above, an aperiodic channel state information (A-CSI) transmission may be triggered by a grant in downlink control information (DCI) and piggybacked on a slot aggregated channel. According to aspects of the present disclosure, a user equipment (UE) may determine which of the aggregated slots to send the A-CSI and a base station (BS) may determine which of the aggregated slots to monitor the A-CSI. In some examples, the A-CSI may include a part 1 and part 2. For example, the first part may include information related to the second part.

According to aspects of the present disclosure, the UE may transmit (and the BS may monitor) the A-CSI in only one slot of the slot aggregated slots, as discussed in more detail in the examples below. For example, the UE piggybacks the A-CSI with a slot aggregated transmission in one of the aggregated slots. In some example, the UE may be configured with a rule (or a mode) for which slot to send the A-CSI.

In some examples, the UE sends the A-CSI in the first slot of the aggregated slots. For example, the UE may a follow a “first slot” rule, in which the UE always transmits the A-CSI on the first slot (e.g., the earliest slot) of the aggregated slots. In this example, the network scheduler (e.g., a BS) may be responsible for enforcing the A-CSI gap. For example, as discussed above, A-CSI transmission may satisfy a first time gap threshold (Z symbols) for a time gap between the last orthogonal frequency-division multiplexing (OFDM) symbol of the physical downlink control channel (PDCCH) carrying the grant to the first OFDM symbol of the aggregated slot carrying the A-CSI report. As discussed above, the A-CSI also satisfies a second time gap threshold (Z′ symbols) for a time gap from the last OFDM symbol of the CSI reference signal (RS), which may be triggered/scheduled by the DCI, to the first OFDM symbol of the aggregated slot carrying the A-CSI report. The time gaps threshold may ensure that the UE has enough time to prepare the A-CSI report. Thus, the network scheduler may ensure that the distance between the DCI carrying the grant and the first aggregated slot is greater than or equal to the first time threshold and ensure that the distance from the triggered A-CSI-RS to the first aggregated slot is greater than or equal to the second time gap threshold. The UL grant schedules the first aggregated physical uplink shared channel (PUSCH) slot (PUSCH slot 1) a distance that is Z′ symbols after the CSI-RS and Z symbols after the UL grant.

In some examples, the UE sends the A-CSI in the first (e.g., earliest) aggregated slot among the aggregated slots that satisfy the time gap thresholds (Z and Z1). If the time gap thresholds are not satisfied by the first aggregated slot (PUSCH slot 1), the UE can report on the second aggregated slot (PUSCH slot 2), which is the first slot of the aggregated slots that satisfy the time gap thresholds (e.g., PUSCH slot 2, PUSCH 3, and PUSCH slot 4). In this configuration, network scheduler may not enforce the time gap thresholds (e.g., adjust transmission schedule), or has a less restrictive enforcement only to some of the aggregated slots. Instead, the UE determines the earliest aggregated slot that satisfies the time gap thresholds and then determines to send the A-CSI on that aggregated slot.

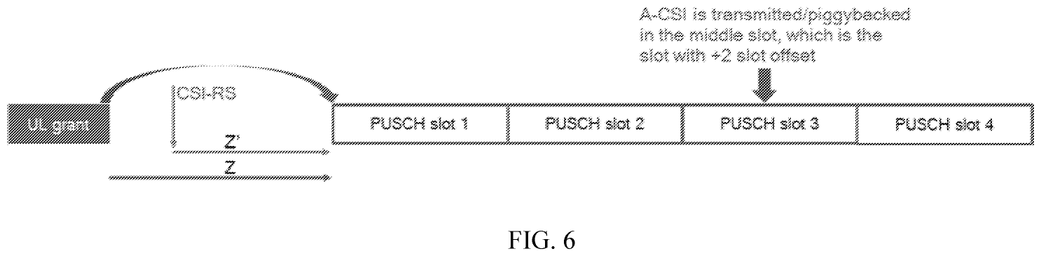

As shown in FIG. 6, in some cases, the UE sends the A-CSI in a middle slot among the aggregated slots that satisfy the time gap thresholds. The middle slot may be determined as: slot offset=floor(subgroup size/2). The middle slot may be determined as ceiling(subgroup size/2). The slot offset is with respect to the earliest aggregated slot satisfying the timeline (e.g., PUSCH slot 2). The subgroup is size is the number of aggregated slots satisfying the time gap thresholds (e.g., 3 slots). The UE sends the A-CSI in the PUSCH slot 3, which is the middle slot of the slots satisfying the Z and Z′ thresholds (PUSCH slot 2, PUSCH slot 3, and PUSCH slot 4). In some cases, the middle slot may provide the best channel estimation performance.

In some examples, the UE sends the A-CSI in every slot of the aggregated slots. For example, the UE repeats the A-CSI transmission on all of the aggregated slots, which may provide improved A-CSI decoding performance. In this configuration, the BS network scheduler may enforce the A-CSI timeline on all of the aggregated slots.

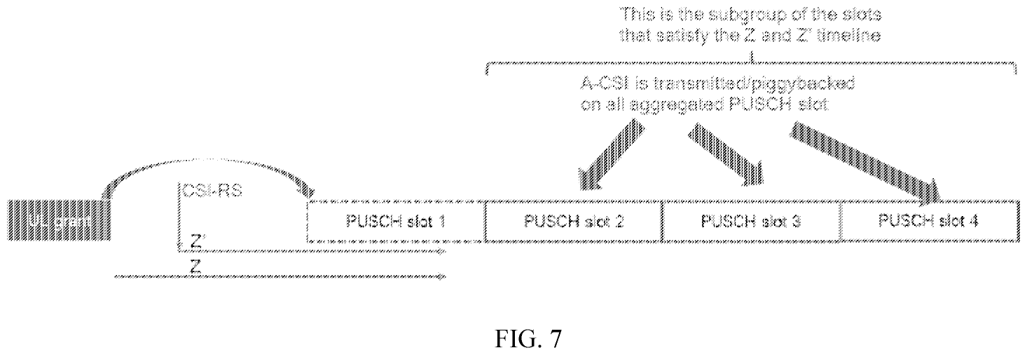

In some examples, the UE sends the A-CSI transmission in only the aggregated slots that satisfy the time gap threshold, as shown in FIG. 7. In this configuration, the BS network scheduler may not enforce the timeline (or may enforce timeline for a subgroup of the slots). Instead, the UE may determine which of the aggregated slots satisfy the timeline and transmit the A-CSI on all of those slots.

### Example Methods for CSI Report Transmitted on Multi-Slot PUSCH

In some cases, different aggregated PUSCH slots may have different CSI timing thresholds depending on what types of signals are transmitted on the PUSCH slots. For example, Z/Z′ values may be dependent on whether HARQ-ACK is transmitted in a slot. If there is no If no HARQ-ACK, Z/Z′ may be shorter than if HARQ-ACK is transmitted. FIG. 5B illustrates example definition for timing parameter Z and Z′. If no HARQ-ACK, no data, and no CSI processing unit (CPU) occupied before calculating the CSI (to be transmitted on the multi PUSCH slots), and if the CSI is a single CSI with single resource and the codebook type is Type I single panel or the report quantity of the CSI is non-PMI, then it CSI reporting follows the shorter timing shown in the table of FIG. 5B. Otherwise, if there is either HARQ-ACK or data, but the CSI is a single CSI with single resource and the codebook type is Type I single panel or the report quantity of the CSI is non-PMI, CSI reporting follows a longer timing; else the CSI reporting, follows the longest table shown in FIG. 5C if the report is related to CSI report (not beam management related report).

This potential difference is CSI timing conditions may present a challenge when A-CSI is transmitted on multiple PUSCH slots. For example, there may be ambiguity in how to determine CSI timing conditions when there is HARQ-ACK on a subset of the PUSCH slots, then Z/Z′ values change across slots.

As noted above, Z refers to a minimum time gap from the last OFDM symbol of the PDCCH carrying UL grant to the first OFDM symbol of PUSCH carrying A-CSI report (this gap should be >=Z symbols), while Z′ refers to the minimum time gap from the last OFDM symbol of the CSI-RS to the first OFDM symbol of PUSCH carrying the A-CSI report (this gap should be >=Z′ symbols).

Aspects of the present disclosure provide techniques that may help determine CSI timing conditions, when A-CSI is transmitted on multiple PUSCH slots, but certain signals (such as HARQ-ACK) that impact the CSI timing conditions for a PUSCH slot are transmitted on only a subset of the PUSCH slots.

FIG. 8 illustrates example operations 800 for wireless communication, in accordance with certain aspects of the present disclosure. The operations 800 may be performed, for example, by UE (e.g., such as a UE 120a of FIG. 1 or FIG. 2.

Operations 800 begin, at 805, by the UE receiving a grant triggering an A-CSI transmission in a slot overlapping a scheduled transmission with slot aggregation of multiple PUSCH slots.

At 810, the UE determines CSI timing conditions based on a set of signals transmitted on only a subset of the multiple PUSCH slots.

At 815, the UE sends A-CSI reports in one or more of the aggregated slots that satisfy the CSI timing conditions.

FIG. 9 illustrates example operations 900 for wireless communications by a network entity that may be considered complementary to operations 800 of FIG. 8. For example, operations 900 may be performed by a network entity to trigger a UE performing operations 800 to send an A-CSI report.

Operations 900 begin, at 905, by sending a UE a grant triggering an A-CSI transmission in a slot overlapping a scheduled transmission with slot aggregation of multiple PUSCH slots.

At 910, the network entity determines CSI timing conditions based on a set of signals transmitted on only a subset of the multiple PUSCH slots.

At 915, the network entity monitors for A-CSI reports in one or more of the aggregated slots that satisfy the CSI timing conditions.

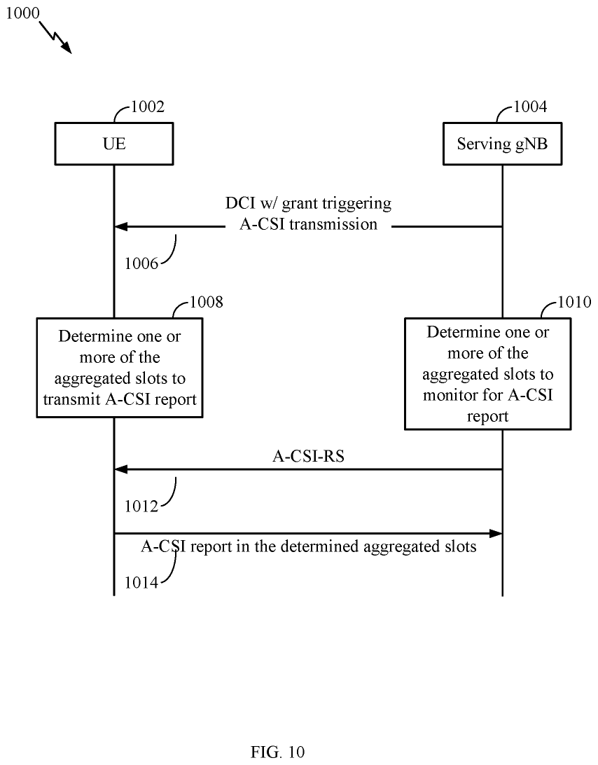

FIG. 10 is a call flow diagram illustrating example signaling 1000 for A-CSI with slot aggregation, in accordance with aspects of the present disclosure. As shown in FIG. 10, the UE 1002 may receive DCI from the BS 1004 triggering A-CSI with slot aggregation. At 1008, the UE 1002 determines one or more of the aggregated slots to transmit A-CSI (e.g., that satisfy CSI timing conditions determined based on a set of signals transmitted on only a subset of the multiple PUSCH slots). At 1010, the BS 1004 determines one or more of the aggregated slots to monitor A-CSI (e.g., based on a set of signals transmitted on only a subset of the multiple PUSCH slots). At 1012, the BS 1004 sends the UE 1002 A-CSI-RS. The UE 1002 measures the A-CSI and computes the CSI. At 1014, the UE 1002 sends the A-CSI report to the BS 1004 in the determined aggregated slots.

There are various alternatives for how to determine CSI timing conditions (e.g., based parameters Z/Z′) and on which PUSCH slots to transmit A-CSI reports, based on a set of signals transmitted on only a subset of the multiple PUSCH slots.

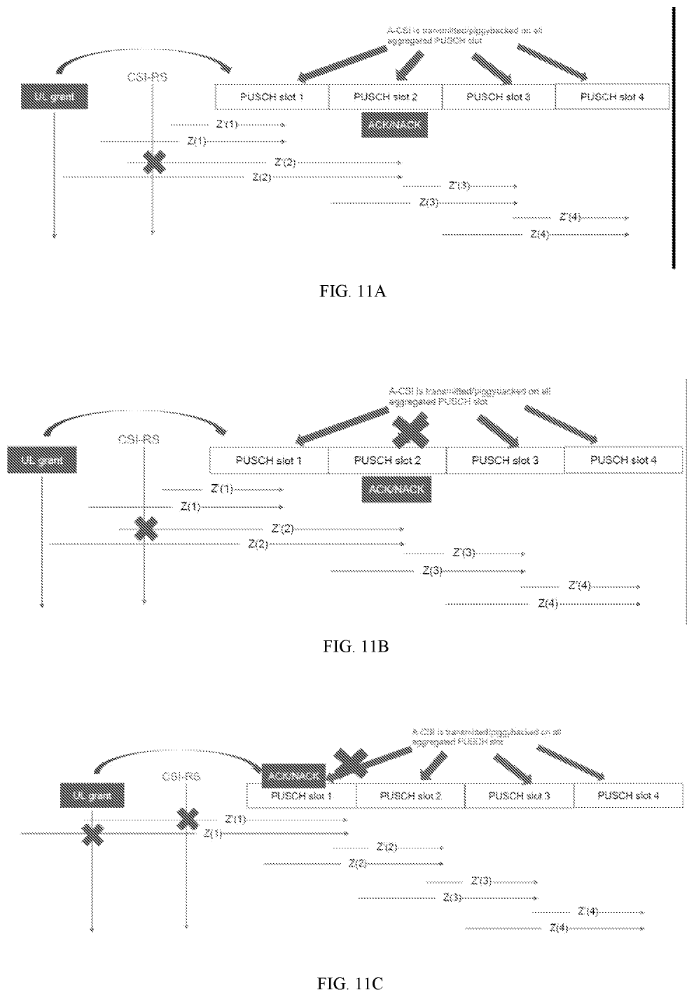

FIG. 11A illustrates a first alternative, where A-CSI reports may be sent on a first slot that satisfies the CSI timing conditions and all slots thereafter. As illustrated in FIG. 11C, HARQ ACK may only be transmitted in PUSCH slot 2.

As in the illustrated, if the CSI timing conditions for the first slot, Z(1)/Z(1)′, are satisfied, the UE may transmit A-CSI on all the PUSCH slots. If, on the other hand, if Z(1)/Z(1)′ were not satisfied, the UE may ignore the CSI or the UE may not update the CSI otherwise (e.g., the UE may still transmit outdated CSIs on all the PUSCH slots).

As illustrated in FIG. 11A, the Z/Z′ value in PUSCH slots 1, 3, and 4 will be shorter (no HARQ ACK), while the Z/Z′ in PUSCH slot 2 will be longer. In the example, Z′(1) is within the bounds of both the UL grant and the end of slot 1, so Z′(1) is valid and, in this example, the UE transmits CSI on all the remaining slots.

FIG. 11B illustrates a second alternative, in which the timing conditions are determined for each slot. In this cases, A-CSI reports are sent only on the slots n that satisfy the timing conditions Z(n)/Z′(n). For slots n where Z(n)/Z(n)′ are not satisfied, the UE may ignore the CSI if there is no HARQ-ACK or data or the UE may not update the CSI otherwise.

In the example illustrated in FIG. 11B, only PUSCH slot 2 fails to satisfy the CSI timing conditions, due to the increased duration of Z(3) and Z′(3) due to HARQ ACK on this slot. In other words, the condition of Z′(2) is not satisfied for slot 2 because the start of Z′(2) is before the CSI-RS. Therefore, A-CSI is transmitted on only the other three slots (slots 1, 3, and 4).

FIG. 11C illustrates a third alternative, which may be considered a hybrid of the first and second alternatives. Rather than rely solely on whether the first PUSCH slot satisfies the CSI timing conditions as with the first alternative shown in FIG. 11A or applying the CSI timing conditions separately per slot (for each of the slots) as with the second alternative, the third alternative allows A-CSI to also be transmitted on all slots (n+1, n+2, etc.) after a slot n that satisfies the CSI timing requirements.

In the example illustrated in FIG. 11C, PUSCH slot 1 fails to satisfy the CSI timing conditions based on both Z(1) and Z′(1). However, since PUSCH slot 2 satisfies the CSI timing conditions, A-CSI is transmitted on PUSCH slots 2, 3, and 4.

In some cases, a rule may dictate that, when the CSI request field on a DCI triggers a CSI report(s) on PUSCH, the UE provides a valid CSI report for the n-th triggered report, if the first uplink symbol of the first PUSCH slot to carry the corresponding CSI report(s) including the effect of the timing advance, starts no earlier than at symbol Z_{ref}, and if the first uplink symbol of the first PUSCH slot to carry the n-th CSI report including the effect of the timing advance, starts no earlier than at symbol Z′ref(n).

Another potential challenge when transmitting CSI-RS with PUSCH slot aggregation is how to determine CSI processing unit (CPU) occupation or active duration and CSI-RS resource occupation. Active CSI RS duration generally counts from when the UE receives the resource and performs the calculation. A UE is generally limited in how many CPUs it supports, which refers to a number of CSI calculations the UE can make. In other words, if a UE supports N CPUs, if L CPUs are occupied for calculation of CSI reports in a given OFDM symbol, the UE has N-L unoccupied CPUs.

Current standards may dictate that for aperiodic CSI-RS, CSI-RS resource occupation starts from the end of the PDCCH containing the request and ends at the end of the PUSCH containing the report associated with this aperiodic CSI-RS. Current standards may dictate that CPU occupation time, for an aperiodic CSI report occupies CPU(s) from the first symbol after the PDCCH triggering the CSI report until the last symbol of the PUSCH carrying the report. For an initial semi-persistent CSI report on PUSCH, CPU occupation time may start after the PDCCH trigger occupies CPU(s) from the first symbol after the PDCCH until the last symbol of the PUSCH carrying the report. For periodic or semi-persistent CSI report (excluding an initial semi-persistent CSI report on PUSCH after the PDCCH triggering the report), CPU occupation time occupies CPU(s) from the first symbol of the earliest one of each CSI-RS/CSI-IM/SSB resource for channel or interference measurement, respective latest CSI-RS/CSI-IM/SSB occasion no later than the corresponding CSI reference resource, until the last symbol of the PUSCH/PUCCH carrying the report.

A potential challenge arises when A/SP-CSI is transmitted on multiple PUSCH slots, as to when will the CSI-RS resource and CPU resources will be considered released. For CSI reports on multiple PUSCH transmissions, CSI resource durations and CPU occupation times may need to be defined.

A potential challenge also arises when trying to determine a CSI reference resource. Agreement between a gNB and UE on a location of the CSI reference resource is important so the gNB knows for what CSI-RS transmission the UE is reporting. For SP reporting, CSI reference resource is downlink slot 4/5 ms (i.e., 4·2^{μ}^{_{DL}} or 5·2^{μ}^{_{DL}} slots, where μ_{DL}, corresponds the subcarrier spacing of the downlink BWP, it is equal to 1,2,3,4 if subcarrier spacing is 15 k, 30 k, 60 k, 120 kHz, respectively) ahead of the PUSCH reporting. For AP reporting, CSI reference resource is downlink slot floor(Z′/14) slots ahead of the PUSCH reporting but, as described above, Z′ may depend on what signals are transmitted in a PUSCH slot (which may vary across slots), as described above and as shown in the tables of FIGS. 5B and 5C.

FIG. 12 is a flow diagram illustrating example operations 1200 for wireless communication by a UE that may help address these potential challenges. Operations 1200 may be performed, for example, by UE (e.g., such as a UE 120a of FIG. 1 or FIG. 2) to determine CSI-RS active duration, CPU occupation time, or a location of a CSI reference resource for reporting CSI with PUSCH slot aggregation.

Operations 1200 begin, at 1205, by the UE receiving signaling triggering or configuring a CSI report transmission in a slot overlapping a scheduled transmission with slot aggregation of multiple PUSCH slots.

At 1210, the UE determines at least one of a CSI-RS active duration, CSI processing unit (CPU) occupation time, or a location of a CSI reference resource for the CSI report, when the CSI report is sent on multiple PUSCH slots.

FIG. 13 illustrates example operations 1300 for wireless communications by a network entity that may be considered complementary to operations 1200 of FIG. 12. For example, operations 1300 may be performed by a network entity to trigger a UE performing operations 1200 to send an A-CSI report.

Operations 1300 begin, at 1305, by sending, to a UE, signaling triggering or configuring a CSI report transmission in a slot overlapping a scheduled transmission with slot aggregation of multiple PUSCH slots.

At 1310, the network entity determining at least one of a CSI-RS active duration, CPU occupation time, or a location of a CSI reference resource for the CSI report, when the CSI report is sent on multiple PUSCH slots.

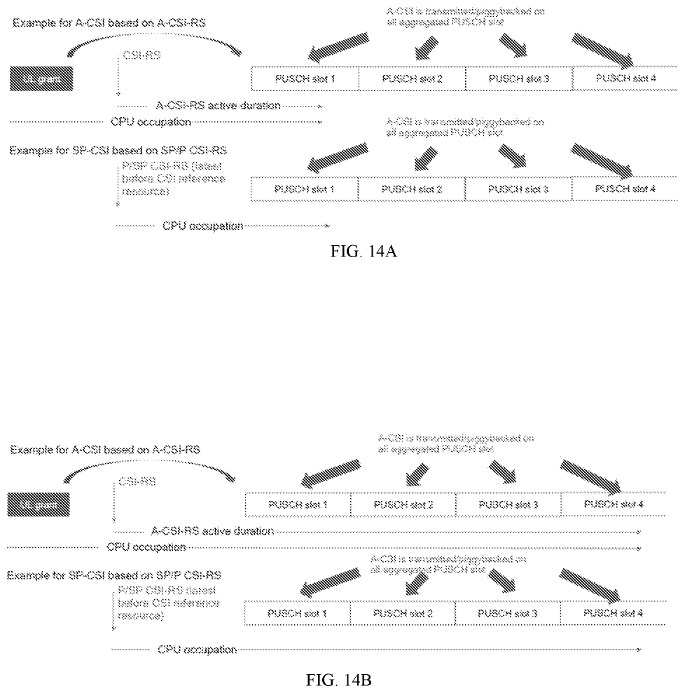

FIG. 14A illustrates one alternative for determining CSI resource and CPU occupation durations and release times. In this example, release occurs at the end of first PUSCH which carries the CSI report

For the A-CSI example shown in FIG. 14A, if the UE transmits A-CSI on all four PUSCH slots, the A-CSI-RS active duration is from the CSI-RS to the end of PUSCH. The CPU occupation starts from the first symbol of the DCI (UL grant) until the last symbol of the PUSCH. For the case of Semi-persistent-CSI reporting, since the UE does not have to decode a grant to detect the location of CSI-RS resource, the CPU occupation starts from the latest CSI-RS resource prior to the CSI reference resource to the last symbol of the PUSCH in the first slot that carries the CSI report (PUSCH slot 1).

FIG. 14B illustrates one alternative for determining CSI resource and CPU occupation durations and release times. In this example, A-CSI-RS and CPU occupation lasts until the end of the last symbol of the last PUSCH that carries the CSI report (PUSCH slot 4).

Thus, applying the rules shown in FIGS. 14A and 14B, CSI-RS resource occupation, for aperiodic CSI-RS may be considered as starting from the end of the PDCCH containing the request and ending at the end of the first (FIG. 14A) or last (FIG. 14B) PUSCH containing the report associated with this aperiodic CSI-RS, while CPU occupation time. For an aperiodic CSI report, CPU(s) occupation lasts from the first symbol after the PDCCH triggering the CSI report until the last symbol of the first (FIG. 14A) or last (FIG. 14B) PUSCH carrying the report. For an initial semi-persistent CSI report on PUSCH after the PDCCH trigger, CPU(s) occupation lasts from the first symbol after the PDCCH until the last symbol of the first/last PUSCH carrying the report. Periodic or semi-persistent CSI report (excluding an initial semi-persistent CSI report on PUSCH after the PDCCH triggering the report) may occupy CPU(s) from the first symbol of the earliest one of each CSI-RS/CSI-IM/SSB resource for channel or interference measurement, respective latest CSI-RS/CSI-IM/SSB occasion no later than the corresponding CSI reference resource, until the last symbol of the first/last PUSCH/PUCCH carrying the report.

In some cases, a periodic or semi-persistent CSI report (excluding an initial semi-persistent CSI report on PUSCH after the PDCCH triggering the report) occupies CPU(s) from the first symbol of the earliest one of each CSI-RS/CSI-IM/SSB resource for channel or interference measurement, respective latest CSI-RS/CSI-IM/SSB occasion no later than the corresponding CSI reference resource, until the last symbol of the PUCCH carrying the report or until the last symbol of the first PUSCH slot carrying the report. An aperiodic CSI report may occupy CPU(s) from the first symbol after the PDCCH triggering the CSI report until the last symbol of the first PUSCH slot carrying the report. An initial semi-persistent CSI report on PUSCH after the PDCCH trigger may occupy CPU(s) from the first symbol after the PDCCH until the last symbol of the first PUSCH slot carrying the report.

In some cases, for aperiodic CSI-RS, the active CSI-RS time may start from the end of the PDCCH containing the request and at the end of the last PUSCH slot containing the report associated with this aperiodic CSI-RS.

In some cases, a periodic or semi-persistent CSI report (excluding an initial semi-persistent CSI report on PUSCH after the PDCCH triggering the report) occupies CPU(s) from the first symbol of the earliest one of each CSI-RS/CSI-IM/SSB resource for channel or interference measurement, respective latest CSI-RS/CSI-IM/SSB occasion no later than the corresponding CSI reference resource, until the last symbol of the PUCCH carrying the report or until the last symbol of the last PUSCH slot carrying the report. An aperiodic CSI report may occupy CPU(s) from the first symbol after the PDCCH triggering the CSI report until the last symbol of the last PUSCH slot carrying the report. An initial semi-persistent CSI report on PUSCH after the PDCCH trigger may occupy CPU(s) from the first symbol after the PDCCH until the last symbol of the last PUSCH slot carrying the report.

In some cases, for aperiodic CSI-RS, the active CSI-RS time may start from the end of the PDCCH containing the request and at the end of the last PUSCH slot containing the report associated with this aperiodic CSI-RS.

As noted above, another potential challenge also arises when trying to determine a CSI reference resource for CSI reports with PUSCH slot aggregation. Aspects of the present disclosure provide options for determining a CSI reference resource in such cases.

In some cases, for a CSI report transmitted on multi-slot PUSCH on slot n, n+1, n+2, etc., the CSI reference may be a downlink slot is in slot n-n ref. In some cases, for SP CSI, n_ref=4·2^{μ}^{_{DL}}, where μDᵢ, is the subcarrier spacing of the DL, while n is the first slot transmitting the CSI report if there is a single CSI report on the PUSCH. In some cases, for SP CSI, n_ref=5·2^{μ}^{_{DL}}, where μ_{DL}, is the subcarrier spacing of the DL, while n is the first slot transmitting the CSI report if there is a multiple CSI report on the PUSCH. In some cases, for A CSI, n_ref=└Z′/14┘, where Z′ is the CSI processing timing between CSI-RS and the PUSCH, while n is the first slot transmitting the CSI report.

In some cases, in the time domain, the CSI reference resource for a CSI reporting in uplink slot n′ is defined by a single downlink slot n-n_{CSI_ref}, where n′ is the first PUSCH slot if the CSI reporting is on PUSCH and slot aggregation is enabled and where:

$$n = ⌊ \text{?} ⌋$$

$$\text{?} \text{indicates text missing or illegible when filed}$$

and μ_{DL} and μ_{UL} are the subcarrier spacing configurations for DL and UL, respectively.

These techniques may help define a slot which the gNB and UE agree upon, so the gNB and UE may be aligned on which slot the UE report is based on. Otherwise, there may be no way for the gNB to know the UE report is current and valid and can use the reported values (e.g., for PMI and CQI) for a subsequent PDSCH transmission.

### Example Embodiments

Embodiment 1: A method for wireless communications by a user equipment (UE), comprising: receiving a grant triggering an aperiodic channel state information (A-CSI) transmission in a slot overlapping a scheduled transmission with slot aggregation of multiple physical uplink shared channel (PUSCH) slots; determining CSI timing conditions based on a set of signals transmitted on only a subset of the multiple PUSCH slots; and sending A-CSI reports in one or more of the aggregated slots that satisfy the CSI timing conditions.

Embodiment 2: The method of Embodiment 1, wherein the CSI timing conditions comprise: a first time-gap from an ending symbol of a physical downlink control channel (PDCCH) carrying the grant to a beginning symbol of a PUSCH slot being equal to or greater than a first threshold value; and a second time-gap from an ending symbol of the CSI-RS to the beginning of a PUSCH slot being equal to or greater than a second threshold value.

Embodiment 3: The method of Embodiment 2, wherein the first and second threshold values are determined based on a set of signals transmitted on a first PUSCH slot of the multiple PUSCH slots.

Embodiment 4: The method of Embodiment 3, wherein: if the CSI timing conditions are satisfied in the first PUSCH slot, a A-CSI report is sent on each of the PUSCH slots.

Embodiment 5: The method of any of Embodiments 1-4, wherein the first and second threshold values are determined based on a set of signals transmitted on each PUSCH slot.

Embodiment 6: The method of Embodiment 5, wherein: A-CSI reports are sent only on slots that satisfy the CSI timing conditions.

Embodiment 7: The method of any of Embodiments 1-6, wherein: the first and second threshold values are determined based on a set of signals transmitted on each PUSCH slot; and if a PUSCH slot satisfies the CSI timing conditions, an A-CSI report is sent on that PUSCH slot and all remaining PUSCH slots after that PUSCH slot.

Embodiment 8: A method for wireless communications by a network entity, comprising: sending a user equipment (UE) a grant triggering an aperiodic channel state information (A-CSI) transmission in a slot overlapping a scheduled transmission with slot aggregation of multiple physical uplink shared channel (PUSCH) slots; determining CSI timing conditions based on a set of signals transmitted on only a subset of the multiple PUSCH slots; and monitoring for A-CSI reports in one or more of the aggregated slots that satisfy the CSI timing conditions.

Embodiment 9: The method of Embodiment 8, wherein the CSI timing conditions comprise: a first time-gap from an ending symbol of a physical downlink control channel (PDCCH) carrying the grant to a beginning symbol of a PUSCH slot being equal to or greater than a first threshold value; and a second time-gap from an ending symbol of the CSI-RS to the beginning of a PUSCH slot being equal to or greater than a second threshold value.

Embodiment 10: The method of Embodiment 9, wherein the first and second threshold values are determined based on a set of signals transmitted on a first PUSCH slot of the multiple PUSCH slots.

Embodiment 11: The method of Embodiment 10, wherein: if the CSI timing conditions are satisfied in the first PUSCH slot, a A-CSI report is sent on each of the PUSCH slots.

Embodiment 12: The method of claim 9, wherein the first and second threshold values are determined based on a set of signals transmitted on each PUSCH slot.

Embodiment 13: The method of Embodiment 12, wherein: A-CSI reports are monitored for only on slots that satisfy the CSI timing conditions.

Embodiment 14: The method of any of Embodiments 8-13 wherein: the first and second threshold values are determined based on a set of signals transmitted on each PUSCH slot; and if a PUSCH slot satisfies the CSI timing conditions, an A-CSI report is monitored for on that PUSCH slot and all remaining PUSCH slots after that PUSCH slot.

Embodiment 15: A method for wireless communications by a user equipment (UE), comprising: receiving signaling triggering or configuring a channel state information (CSI) report transmission in a slot overlapping a scheduled transmission with slot aggregation of multiple physical uplink shared channel (PUSCH) slots; and determining at least one of a CSI-RS active duration, CSI processing unit (CPU) occupation time, or a location of a CSI reference resource for the CSI report, when the CSI report is sent on multiple PUSCH slots.

Embodiment 16: The method of Embodiment 15, wherein: if the signaling comprises a grant triggering an aperiodic CSI report, both CSI-RS active duration and a CPU occupation time are determined when the CSI report is sent on multiple PUSCH slots.

Embodiment 17: The method of claim 15, wherein the at least one of the CSI-RS active duration or CPU occupation time ends at an end of a first PUSCH that carries a CSI report.

Embodiment 18: The method of any of Embodiments 15-17, wherein the at least one of the CSI-RS active duration or CPU occupation time ends at an end of a last PUSCH that carries a CSI report.

Embodiment 19: The method of any of Embodiments 15-18, wherein, for an aperiodic CSI report, the location of the CSI reference resource also depends at least in part on the location of a first PUSCH slot carrying the CSI report.

Embodiment 20: The method of Embodiment 19, the timing gap between the CSI reference resource and the location of the first PUSCH slot carrying the CSI report depends on at least one of, CSI resource type, subcarrier spacing of downlink carrier, and whether single or multiple CSI reports are sent on the PUSCH.

Embodiment 21: A method for wireless communications by a network entity, comprising: sending, to a user equipment (UE), signaling triggering or configuring a channel state information (CSI) report transmission in a slot overlapping a scheduled transmission with slot aggregation of multiple physical uplink shared channel (PUSCH) slots; and determining at least one of a CSI-RS active duration, CSI processing unit (CPU) occupation time, or a location of a CSI reference resource for the CSI report, when the CSI report is sent on multiple PUSCH slots.

Embodiment 22: The method of Embodiment 21, wherein: if the signaling comprises a grant triggering an aperiodic CSI report, both CSI-RS active duration and a CPU occupation time are determined when the CSI report is sent on multiple PUSCH slots.

Embodiment 23: The method of any of Embodiments 21-22, wherein the at least one of the CSI-RS active duration or CPU occupation time ends at an end of a first PUSCH that carries a CSI report.

Embodiment 24: The method of any of Embodiments 21-23, wherein the at least one of the CSI-RS active duration or CPU occupation time ends at an end of a last PUSCH that carries a CSI report.

Embodiment 25: The method of any of Embodiments 21-23, wherein, for an aperiodic CSI report, the location of the CSI reference resource also depends at least in part on the location of a first PUSCH slot carrying the CSI report.

Embodiment 26: The method of Embodiment 25, the timing gap between the CSI reference resource and the location of the first PUSCH slot carrying the CSI report depends on at least one of, CSI resource type, subcarrier spacing of downlink carrier, and whether single or multiple CSI reports are sent on the PUSCH.

Embodiment 27: An apparatus for wireless communications by a user equipment (UE), comprising: means for receiving a grant triggering an aperiodic channel state information (A-CSI) transmission in a slot overlapping a scheduled transmission with slot aggregation of multiple physical uplink shared channel (PUSCH) slots; means for determining CSI timing conditions based on a set of signals transmitted on only a subset of the multiple PUSCH slots; and means for sending A-CSI reports in one or more of the aggregated slots that satisfy the CSI timing conditions.

Embodiment 28: An apparatus for wireless communications by a network entity, comprising: means for sending a user equipment (UE) a grant triggering an aperiodic channel state information (A-CSI) transmission in a slot overlapping a scheduled transmission with slot aggregation of multiple physical uplink shared channel (PUSCH) slots; means for determining CSI timing conditions based on a set of signals transmitted on only a subset of the multiple PUSCH slots; and means for monitoring for A-CSI reports in one or more of the aggregated slots that satisfy the CSI timing conditions.

Embodiment 29: An apparatus for wireless communications by a user equipment (UE), comprising: means for receiving signaling triggering or configuring a channel state information (CSI) report transmission in a slot overlapping a scheduled transmission with slot aggregation of multiple physical uplink shared channel (PUSCH) slots; and means for determining at least one of a CSI-RS active duration, CSI processing unit (CPU) occupation time, or a location of a CSI reference resource for the CSI report, when the CSI report is sent on multiple PUSCH slots.

Embodiment 30: An apparatus for wireless communications by a network entity, comprising: means for sending, to a user equipment (UE), signaling triggering or configuring a channel state information (CSI) report transmission in a slot overlapping a scheduled transmission with slot aggregation of multiple physical uplink shared channel (PUSCH) slots; and means for determining at least one of a CSI-RS active duration, CSI processing unit (CPU) occupation time, or a location of a CSI reference resource for the CSI report, when the CSI report is sent on multiple PUSCH slots.

Embodiment 31: An apparatus for wireless communications by a user equipment (UE), comprising: a receiver configured to receive a grant triggering an aperiodic channel state information (A-CSI) transmission in a slot overlapping a scheduled transmission with slot aggregation of multiple physical uplink shared channel (PUSCH) slots; at least one processor configured to determine CSI timing conditions based on a set of signals transmitted on only a subset of the multiple PUSCH slots; and a transmitter configured to send A-CSI reports in one or more of the aggregated slots that satisfy the CSI timing conditions.

Embodiment 32: An apparatus for wireless communications by a network entity, comprising: a transmitter configured to send a user equipment (UE) a grant triggering an aperiodic channel state information (A-CSI) transmission in a slot overlapping a scheduled transmission with slot aggregation of multiple physical uplink shared channel (PUSCH) slots; and at least one processor configured to determine CSI timing conditions based on a set of signals transmitted on only a subset of the multiple PUSCH slots and monitor for A-CSI reports in one or more of the aggregated slots that satisfy the CSI timing conditions.

Embodiment 33: An apparatus for wireless communications by a user equipment (UE), comprising: a receiver configured to receive signaling triggering or configuring a channel state information (CSI) report transmission in a slot overlapping a scheduled transmission with slot aggregation of multiple physical uplink shared channel (PUSCH) slots; and at least one processor configured to determine at least one of a CSI-RS active duration, CSI processing unit (CPU) occupation time, or a location of a CSI reference resource for the CSI report, when the CSI report is sent on multiple PUSCH slots.

Embodiment 34: An apparatus for wireless communications by a network entity, comprising: a transmitter configured to send, to a user equipment (UE), signaling triggering or configuring a channel state information (CSI) report transmission in a slot overlapping a scheduled transmission with slot aggregation of multiple physical uplink shared channel (PUSCH) slots; and at least one processor configured to determine at least one of a CSI-RS active duration, CSI processing unit (CPU) occupation time, or a location of a CSI reference resource for the CSI report, when the CSI report is sent on multiple PUSCH slots.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. ABS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications by a user equipment (UE), comprising:
receiving a grant triggering an aperiodic channel state information (A-CSI) transmission in a slot overlapping a scheduled transmission with slot aggregation of multiple physical uplink shared channel (PUSCH) slots;
determining CSI timing conditions based on a set of signals transmitted on only a subset of the multiple PUSCH slots; and
sending A-CSI reports in one or more of the aggregated slots that satisfy the CSI timing conditions.

2. The method of claim 1, wherein the CSI timing conditions comprise:
a first time-gap from an ending symbol of a physical downlink control channel (PDCCH) carrying the grant to a beginning symbol of a PUSCH slot being equal to or greater than a first threshold value; and
a second time-gap from an ending symbol of the CSI-RS to the beginning of a PUSCH slot being equal to or greater than a second threshold value.

3. The method of claim 2, wherein the first and second threshold values are determined based on a set of signals transmitted on a first PUSCH slot of the multiple PUSCH slots.

4. The method of claim 3, wherein:
if the CSI timing conditions are satisfied in the first PUSCH slot, a A-CSI report is sent on each of the PUSCH slots.

5. The method of claim 2, wherein the first and second threshold values are determined based on a set of signals transmitted on each PUSCH slot.

6. The method of claim 5, wherein:
A-CSI reports are sent only on slots that satisfy the CSI timing conditions.

7. The method of claim 5, wherein:
the first and second threshold values are determined based on a set of signals transmitted on each PUSCH slot; and
if a PUSCH slot satisfies the CSI timing conditions, an A-CSI report is sent on that PUSCH slot and all remaining PUSCH slots after that PUSCH slot.

8. A method for wireless communications by a network entity, comprising:
sending a user equipment (UE) a grant triggering an aperiodic channel state information (A-CSI) transmission in a slot overlapping a scheduled transmission with slot aggregation of multiple physical uplink shared channel (PUSCH) slots;
determining CSI timing conditions based on a set of signals transmitted on only a subset of the multiple PUSCH slots; and
monitoring for A-CSI reports in one or more of the aggregated slots that satisfy the CSI timing conditions.

9. The method of claim 8, wherein the CSI timing conditions comprise:
a first time-gap from an ending symbol of a physical downlink control channel (PDCCH) carrying the grant to a beginning symbol of a PUSCH slot being equal to or greater than a first threshold value; and
a second time-gap from an ending symbol of the CSI-RS to the beginning of a PUSCH slot being equal to or greater than a second threshold value.

10. The method of claim 9, wherein the first and second threshold values are determined based on a set of signals transmitted on a first PUSCH slot of the multiple PUSCH slots.

11. The method of claim 10, wherein:
if the CSI timing conditions are satisfied in the first PUSCH slot, a A-CSI report is sent on each of the PUSCH slots.

12. The method of claim 9, wherein the first and second threshold values are determined based on a set of signals transmitted on each PUSCH slot.

13. The method of claim 12, wherein:
A-CSI reports are monitored for only on slots that satisfy the CSI timing conditions.

14. The method of claim 12, wherein:
the first and second threshold values are determined based on a set of signals transmitted on each PUSCH slot; and
if a PUSCH slot satisfies the CSI timing conditions, an A-CSI report is monitored for on that PUSCH slot and all remaining PUSCH slots after that PUSCH slot.

15. A method for wireless communications by a user equipment (UE), comprising:
receiving signaling triggering or configuring a channel state information (CSI) report transmission in a slot overlapping a scheduled transmission with slot aggregation of multiple physical uplink shared channel (PUSCH) slots; and
determining at least one of a CSI-RS active duration, CSI processing unit (CPU) occupation time, or a location of a CSI reference resource for the CSI report, when the CSI report is sent on multiple PUSCH slots.

16. The method of claim 15, wherein:
if the signaling comprises a grant triggering an aperiodic CSI report, both CSI-RS active duration and a CPU occupation time are determined when the CSI report is sent on multiple PUSCH slots.

17. The method of claim 15, wherein the at least one of the CSI-RS active duration or CPU occupation time ends at an end of a first PUSCH that carries a CSI report.

18. The method of claim 15, wherein the at least one of the CSI-RS active duration or CPU occupation time ends at an end of a last PUSCH that carries a CSI report.

19. The method of claim 15, wherein, for an aperiodic CSI report, the location of the CSI reference resource also depends at least in part on the location of a first PUSCH slot carrying the CSI report.

20. The method of claim 19, the timing gap between the CSI reference resource and the location of the first PUSCH slot carrying the CSI report depends on at least one of, CSI resource type, subcarrier spacing of downlink carrier, and whether single or multiple CSI reports are sent on the PUSCH.

21. A method for wireless communications by a network entity, comprising:
sending, to a user equipment (UE), signaling triggering or configuring a channel state information (CSI) report transmission in a slot overlapping a scheduled transmission with slot aggregation of multiple physical uplink shared channel (PUSCH) slots; and
determining at least one of a CSI-RS active duration, CSI processing unit (CPU) occupation time, or a location of a CSI reference resource for the CSI report, when the CSI report is sent on multiple PUSCH slots.

22. The method of claim 21, wherein:
if the signaling comprises a grant triggering an aperiodic CSI report, both CSI-RS active duration and a CPU occupation time are determined when the CSI report is sent on multiple PUSCH slots.

23. The method of claim 21, wherein the at least one of the CSI-RS active duration or CPU occupation time ends at an end of a first PUSCH that carries a CSI report.

24. The method of claim 21, wherein the at least one of the CSI-RS active duration or CPU occupation time ends at an end of a last PUSCH that carries a CSI report.

25. The method of claim 21, wherein, for an aperiodic CSI report, the location of the CSI reference resource also depends at least in part on the location of a first PUSCH slot carrying the CSI report.

26. The method of claim 25, the timing gap between the CSI reference resource and the location of the first PUSCH slot carrying the CSI report depends on at least one of, CSI resource type, subcarrier spacing of downlink carrier, and whether single or multiple CSI reports are sent on the PUSCH.

27-34. (canceled)
